(19) United States
(12) Patent Application Publication
(10) Pub. No.: US 2011/0185054 A1
(43) Pub. Date: Jul. 28, 2011

(54) TERMINAL DEVICE AND CONNECTION SWITCHING MANAGEMENT METHOD

(75) Inventor: Tetsuya Sakai, Tokyo (JP)

(73) Assignee: Panasonic Corporation, Osaka (JP)

(21) Appl. No.: 13/121,639

(22) PCT Filed: Aug. 21, 2009
(86) PCT No.: PCT/JP2009/004015

§ 371 Date: Mar. 29, 2011

(30) Foreign Application Priority Data
Oct. 2, 2008 (JP) 2008-257022

(51) Int. Cl. G06F 15/173

(52) U.S. Cl. 709/223

(57) ABSTRACT

Provided is a terminal device which can perform connection switching to a more appropriate communication network while normally executing a service from a server. The terminal device includes: an input unit (101) which operation-inputs a service provided by a server and outputs to an input management unit (102), the operation input information as information which has been operation-inputted; the input management unit (102) which manages output of the operation input information to an application operating as a service corresponding to the operation input information inputted from the input unit (101); and a switching management unit (108) which performs switching between a first communication network and a second communication network as a communication route between the local device and the server which is providing a service to the local device. Upon detection of operation input information inputted from the input management unit (102), the switching management unit (108) cannot perform switching of the communication network.

### TECHNICAL FIELD

The present invention relates to a terminal apparatus and a connection switching management method.

### BACKGROUND ART

It is anticipated that, in future communication systems, various communication technologies including a WLAN (Wireless Local Area Network) system, 3G (Third Generation Mobile Communication) system and the like exist in a mixed manner, which causes areas to be covered by communication networks of a plurality of communication technologies to overlap.

When a terminal apparatus (hereinafter referred to as “terminal”) is located in an area where areas covered by a plurality of varying communication networks overlap, that is, when a terminal is able to use any of a plurality of communication networks as a communication route to a server being a service provider, the terminal switches the connection to, for example, a communication network of a higher communication speed (see, for example, patent literature 1). For example, when a terminal being connected to a 3G system communication network moves to an area where an area covered by the 3G system communication network and an area covered by a WLAN communication network overlap, the terminal switches the connection to the WLAN communication network that can realize transmission of a higher speed than the 3G system.

### CITATION LIST

### Patent Literature

PTL 1
Japanese Patent Application Laid-Open No. 2004-023768

### SUMMARY OF INVENTION

### Technical Problem

However, when the communication network is switched while service is being executed between a terminal and a server, a case might occur where service cannot be continued. Password authentication will be described below as an example. Now, on each of communication networks A, B, and C in the communication system shown in FIG. 1, separate IP addresses (i.e. local addresses) are assigned to a server, a terminal and suchlike apparatuses, per communication network. For example, on network C, mutually different IP addresses are assigned to server A, server B, terminal B, GW (Gateway) 1, and GW 2, to distinguish between these devices. On networks A and B shown in FIG. 1, as in the case of network C, varying IP addresses are assigned to devices. That is, on each of communication networks A, B, and C shown in FIG. 1, IP addresses are assigned to devices located on the network, independently of other communication networks. Also, the area covered by network B is partially included in the area covered by network A. Moreover, for example, network B can realize transmission of a higher transmission speed than network A, so that network B is given higher priority than network A to be used for communication between a terminal and a server. That is, in communication between terminal A and server A, if both network A and network B can be used (that is, when terminal A is located on network B), network B is used preferentially.

Furthermore, password authentication is performed between terminal A located on network A and server A located on network C shown in FIG. 1. That is, terminal A communicates with server A located on network C through network A serving as a communication route. In addition, upon password authentication, server A identifies a plurality of terminals requesting service from server A, based on the IP addresses of requesting sources that request service from server A.

FIG. 2 is a sequence diagram showing processes of password authentication between terminal A and server A. As shown in FIG. 2, in step (hereinafter referred to as “ST”) 1, terminal A specifies server A as a service provider.

In ST 2, terminal A transmits a screen display request for server A to GW 1, which is located between network A and network C shown in FIG. 1. In ST 3, GW 1 converts the source address of the display request from terminal A into its own IP address (IP-A) on network C, and transmits a display request with a converted source address to server A.

In ST 4, server A judges that password authentication is necessary for the display request received, and, in ST 5, transmits password input data for requesting an input of a password as a response to the display request, to GW 1 being the source (IP-A) of the display request. In ST 6, by performing address conversion (reverse address conversion) being reverse to the address conversion performed in ST 3, GW 1 transmits the password input data from server A to terminal A. Thus, when communication is to be performed between different communication networks (here, network A and network C), a GW (here, GW 1) connected between the communication networks performs IP addresses conversion, thereby allowing communication between devices located on varying communication networks (here, between terminal A located on network A and server A located on network C). That is, terminal A located on network A communicates with server A located on network C using the IP address (IP-A) of GW 1 located between network A and network C. The same applies to GW 2 shown in FIG. 1.

In ST 7, terminal A displays a password request screen.

Suppose that terminal A has moved to an area where the area covered by network A and the area covered by network B overlap. In this case, terminal A can realize transmission of a higher speed by connecting with network B, than by connecting with network A, and, in ST 8, switches the connection to network B, as the communication route to server A. FIG. 3 shows a flow of connection switching processing for communication networks to be performed by terminal A. As shown in FIG. 3, when terminal A is able to communicate with server A through network B, that is, when terminal A is already connected to network B (ST 101: YES), terminal A switches the connection from network A to network B as the communication route to server A (ST 102). Additionally, terminal A, if not connected to network B (ST 101: NO), communicates with server A, continuing using network A.

In ST 9, terminal A inputs a password (“1234” in FIG. 2) on the password request screen displayed in ST 7. In ST 10, terminal A transmits the password for server A to GW 2, which is located between network B and network C shown in FIG. 1. That is, the destination (GW 1 or GW 2) to which terminal A transmits information for server A varies between the time of transmitting a display request in ST 2 and the time of transmitting a password in ST 10. In ST 11, as in the case of GW 1 in ST 3, GW 2 converts the source address of the request for a password from terminal A, into its own IP address (IP-B) on network C, and transmits the password with a converted source address to server A.

As described above, server A identifies terminals based on IP addresses. While the destination address of password input data is IP-A, the source address of the password is IP-B, and therefore server A recognizes that the password has been transmitted from a different terminal, and password authentication fails (ST 12). That is to say, server A judges that the password has been transmitted from a terminal (IP-B) to which server A has not requested transmission of a password, or judges that the password has not been transmitted from the terminal (IP-A) to which server A has requested transmission of a password. In ST 13, server A transmits a password authentication result (failure) as a response to the password transmission request, to GW 2 being the source (IP-B) of the password. In ST 14, GW 2 performs the reverse address conversion and transmits the password authentication result (failure) to terminal A. In ST 15, terminal A displays the authentication result.

Thus, if terminal A switches the communication network connection during the period of time between a request for an input of a password and transmission of a password, the IP address of terminal A on network C becomes different before and after the switching of the communication network connection. Consequently, server A identifies the terminal of the destination to which server A has transmitted password input data, and the terminal of the source of the password, as different terminals.

That is, when service is provided by using a combination of a plurality of messages such as a request and a response to that request, as shown with a password request (ST 2-ST 6 shown in FIG. 2) and password transmission (ST 10 to ST 14 shown in FIG. 2) upon password authentication, if connection is switched to a different communication network (network A or network B) during a period of time over a plurality of mutually related requests (ST 8 shown in FIG. 2), the source (GW 1 or GW 2) of each request becomes different. Due to the above reason, the server judges that these requests are all from different terminals. Therefore, if connection is switched to a different communication network during a period of time over a plurality of mutually related requests, service cannot be continued between a terminal and a server providing service to that terminal.

It is therefore an object of the present invention to provide a terminal apparatus and a connection switching management method capable of correctly executing service from a server and switching connection to a more appropriate communication network.

### Solution to Problem

A terminal apparatus of the present invention employs a configuration having: a managing section that manages switching of connection with a first communication network and a second communication network each serving as a communication route between the terminal apparatus and a server providing service to the terminal apparatus; and an inputting section that performs an operation input for executing the service, and, in this terminal apparatus, when the operation input is detected or when data transmitted from the server comprises information to request a reply by the operation input, the managing section does not switch the connection.

A connection switching management method of the present invention is configured to include managing switching of connection with a first communication network and a second communication network each serving as a communication route between a terminal apparatus and a server providing service to the terminal apparatus, and, with this connection switching management method, when an operation input for executing the service is detected or when data transmitted from the server comprises information to request a reply by the operation input, the connection is not switched.

### Advantageous Effects of Invention

According to the present invention, it is possible to correctly execute service from a server and switch connection to a more suitable communication network.

### BRIEF DESCRIPTION OF DRAWINGS

FIG. 1 illustrates a communication system;

FIG. 2 is a sequence diagram showing a conventional password authentication;

FIG. 3 illustrates a flow of conventional processing of switching connection of communication networks;

FIG. 4 is a block diagram showing configurations of a terminal according to Embodiment 1 of the present invention;

FIG. 5 is a sequence diagram showing password authentication according to Embodiment 1 of the present invention;

FIG. 6 illustrates a flow of processing of switching connection of communication networks according to Embodiment 1 of the present invention;

FIG. 7 is a block diagram showing configurations of a terminal according to Embodiment 2 of the present invention;

FIG. 8A illustrates one example of a HTML (Hyper Text Makeup Language) tag according to Embodiment 3 of the present invention; and

FIG. 8B illustrates an example of execution of HTML data according to Embodiment 3 of the present invention.

### DESCRIPTION OF EMBODIMENTS

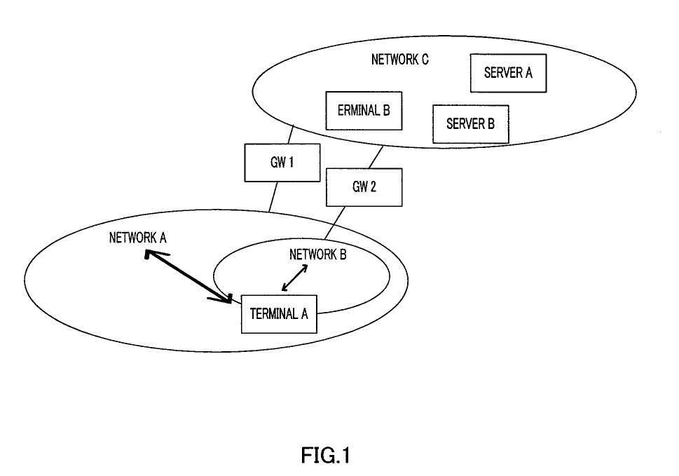

Now, embodiments of the present invention will be described below in detail with reference to the accompanying drawings. In the description below, as a communication route between a terminal and a server, one of a first communication network (for example, network A shown in FIG. 1) and a second communication network (for example, network B shown in FIG. 1) is used. Moreover, in the description below, the second communication network is used with a higher priority over the first communication network. The priority of a communication network is determined based on, for example, the specifications of a communication system, the cost of communication, the measure against congestion in the communication network, the speed of communication, and so on.

### Embodiment 1

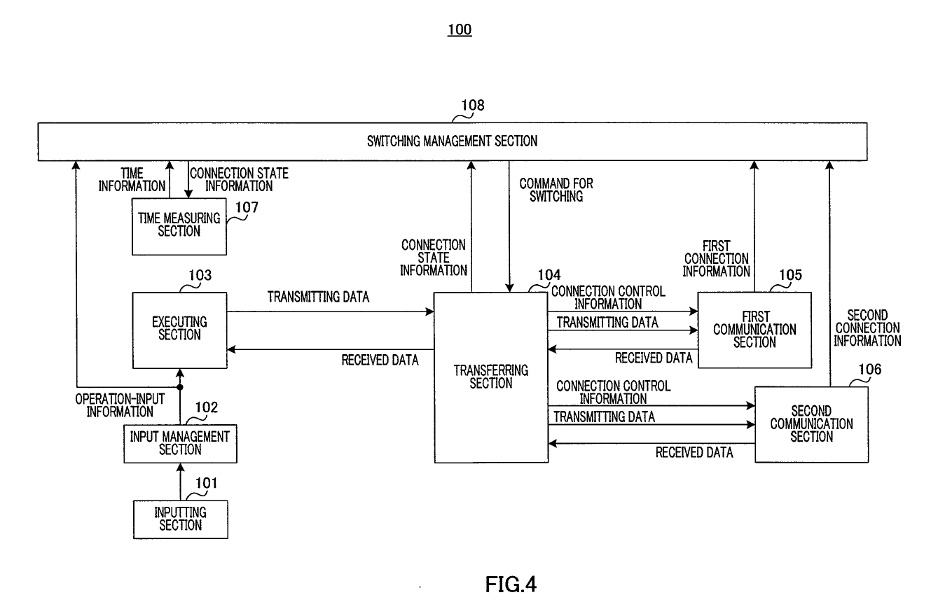

FIG. 4 illustrates configurations of terminal 100 according to the present embodiment.

In terminal 100 of FIG. 4, inputting section 101 performs an operation input for service to be provided by a server. For example, upon being requested from a server to input a password, inputting section 101 inputs a password in response to the password input request. Next, inputting section 101 outputs operation-input information, which is information input through operation (for example, a password that is input through operation), to input management section 102.

Input management section 102 manages the output of operation-input information to an application that functions as service corresponding to the operation-input information to be input from inputting section 101. For example, input management section 102 outputs the operation-input information to be input from inputting section 101, to executing section 103 that executes the application to run as service corresponding to that operation-input information. Furthermore, input management section 102 outputs the operation-input information to the switching managing section 108.

Executing section 103, by using the operation-input information received as input from input management section 102 or data received from a server or received as input from transferring section 104, executes the application that functions as the service provided by a server. For example, when a password input request is received as data from a server, executing section 103 executes an application using operation-input information representing a password. Next, executing section 103 transmits, to a server, through transferring section 104, transmitting data being an execution result of the application.

Transferring section 104 communicates transmitting data and receiving data between executing section 103 and the server, through one of the first communication network and the second communication network. To be more specific, transferring section 104, in accordance with a switching command from switching management section 108, outputs connection control information showing which one of the first communication network and a second communication network to use for communication with a server, to first communication section 105 which uses the first communication network, and to second communication section 106 which uses the second communication network. For example, upon switching communication network connection, transmitting section 104 requests one of first communication section 105 and second communication section 106 that is currently being used as a communication route to disconnect from the server, and requests the other one to use as a communication route after the switching of connection, to connect with the server. Then, transferring section 104, through the communication section (first communication section 105 or second communication section 106) that is connected with the server by the switching of communication network connection, communicates transmitting data and receiving data between the server and executing section 103. Incidentally, transferring section 104 outputs connection state information showing the state of connection between terminal 100 and the server, out of data received from the server, to switching management section 108. The connection state information contains, for example, information showing the state in which a service request is transmitted from executing section 103 to the server, the state in which a response to the request made by executing section 103 is transmitted from the server to executing section 103, and so on.

First communication section 105, when using the first communication network (for example, network A shown in FIG. 1) as a communication route for communication with the server, communicates data received from the server and data to be transmitted from terminal 100, through the first communication network. In addition, first communication section 105 outputs, to switching management section 108, first connection information about whether or not the first communication network can be used, that is, about whether or not terminal 100 is connected to the first communication network.

Second communication section 106, when using the second communication network (for example, network B shown in FIG. 1) as a communication route for communication with a server, in accordance with connection control information received as input from transferring section 104, communicates data received from the server and data to be transmitted from terminal 100, through the second communication network. Further, second communication section 106 outputs, to switching management section 108, second connection information about whether or not the second communication network can be used, that is, about whether or not terminal 100 is connected to the second communication network.

Time measuring section 107, if the connection state information received as input from switching management section 108 contains information showing a response from a server (for example, a request to input a password) to a request from terminal 100, measures the time having elapsed from the time that information was received as input. Next, when the elapsed time exceeds predetermined time, time measuring section 107 outputs, to switching management section 108, time information indicating that predetermined time has elapsed.

Switching management section 108 manages switching of connection with the first communication network and the second communication network, for a communication route between terminal 100 and the server. To be more specific, switching management section 108 first specifies a communication network that can be used, based on first connection information to be received as input from first communication section 105 and second connection information to be received as input from second communication section 106. For example, if the second communication network, to which priority is given over the currently-connecting first communication network, can be used (since the second communication network can provide a higher speed than the first communication network), switching management section 108 commands transferring section 104 to switch the connection from the first communication network to the second communication network. Moreover, switching management section 108, when connection state information received as input from transferring section 104 contains a response from the server to the request made by terminal 100, outputs that connection state information to time measuring section 107. Then, switching management section 108, when operation-input information is received as input from time measuring section 107 (that is, when predetermined time has elapsed), commands transferring section 104 to switch the connection. However, if the operation-input information provided from input management section 102 is detected before time information is received as input from time measuring section 107, switching management section 108 commands transferring section 104 not to switch the communication network connection.

Next, the details of the processing of switching communication network connection by terminal 100 will be described.

Hereinafter, the processing will be described more specifically. Here, password authentication will be explained as one example of service provided between terminal 100 and a server. Moreover, terminal 100 is located on network A shown in FIG. 1 and the password authentication is performed between terminal 100 and server A located on network C. Furthermore, terminal 100 communicates with server A through network A serving as a communication route. Incidentally, server A, at the time of the password authentication, performs discrimination among a plurality of terminals based on an IP address of a requesting source that requests services.

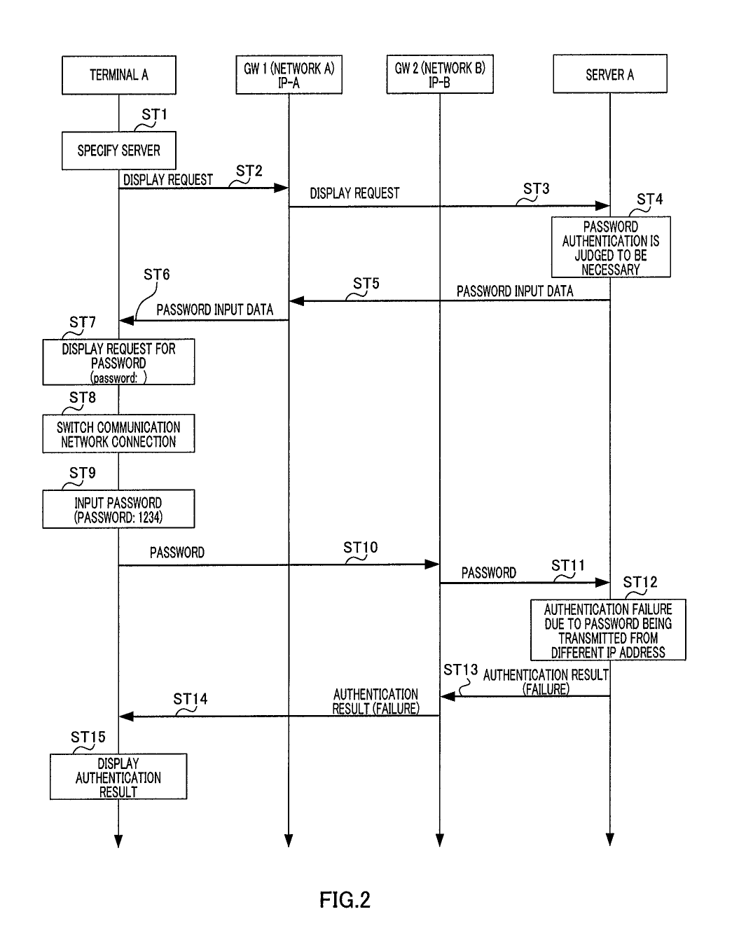

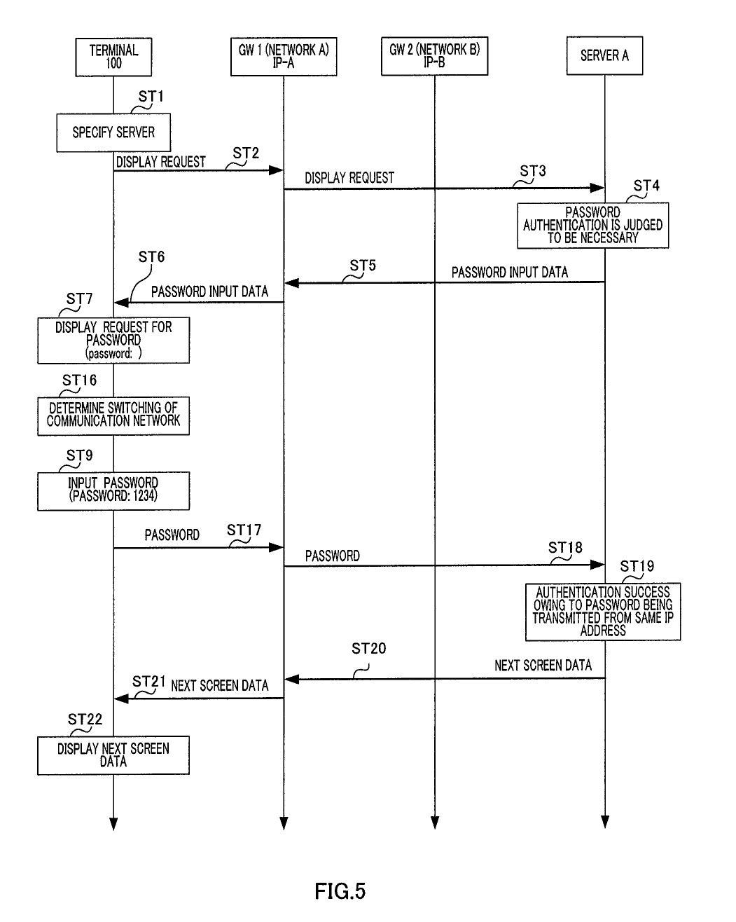

FIG. 5 is a sequence diagram showing the password authentication between server 100 and server A. In FIG. 5, the same reference numerals will be assigned to the same processing as in FIG. 2 and descriptions thereof will be omitted accordingly.

In FIG. 5, after the processing has been completed up to ST 7, it is supposed that terminal 100 has moved to an area where an area covered by network A shown in FIG. 1 and an area covered by network B shown in FIG. 1 are overlapping. In this case, in ST 6, terminal 100 judges whether or not to switch the connection from network A to network B as the communication route to server A.

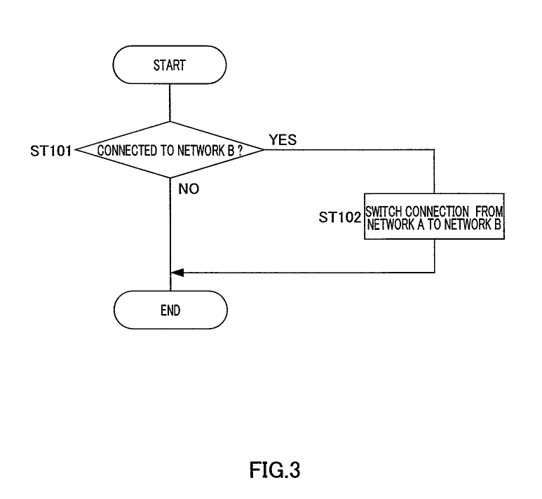

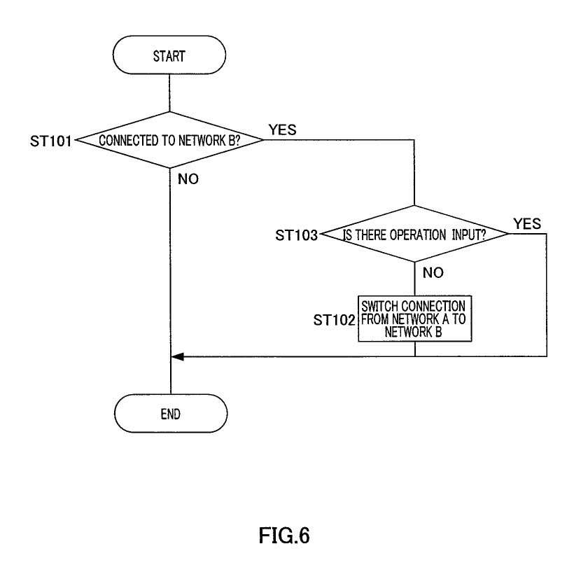

FIG. 6 illustrates a flow of processing of switching communication network connection in terminal 100. In FIG. 6, the same reference numerals will be assigned to the same processing as in FIG. 3 and descriptions thereof will be omitted accordingly. In ST 103, switching management section 108 judges whether or not operation-input information is input from input management section 102. If operation-input information is not detected, that is, if there is no input of operation-input information (ST 103: NO), the processing proceeds to ST 102. Contrarily, if operation-input information is detected, that is, if there is an input of operation-input information (ST 103: YES), switching management section 108 commands transferring section 104 not to switch the connection with the communication network (ST 102). When being commanded by switching management section 108 not to switch the connection, transferring section 104 does not switch the communication network connection, even if it is possible to switch the connection to a communication network of higher priority,

Therefore, in ST 16 shown in FIG. 5, switching management section 108 detects the operation-input information from input management section 102 and commands transferring section 104 not to switch the connection with the communication network (ST 102 shown in FIG. 6).

In ST 17, terminal 100, as in the case of the transmission of the request for displaying in ST 2, transmits a password to access server A to GW 1 shown in FIG. 1. In ST 18, GW 1, as in the case of ST 3, converts the source address of the password from terminal 100 into its own address (IP-A) on network C, and transmits, to server A, the password with a converted source address.

Since the destination address of password input data is IP-A and the source address of the password is IP-A, server A recognizes that the password has been transmitted from the same terminal as the terminal of the destination of the password input data, and the password authentication succeeds (ST 19). In ST 20, server A transmits, as a response to the transmission of the password, for example, next screen data being a next screen of a password input screen, to GW 1 being a source of the password (IP-A). In ST 21, GW 1 performs reverse address conversion and transmits the next screen data to terminal 100. In ST 22, terminal 100 displays the next screen data.

Thus, terminal 100, upon detecting an operation-input, judges that the plurality of requests transmitted before and after the operation input are related, and does not switch the communication network connection. This enables the prevention of service discontinuation caused by connection switching of communication networks during a period of a plurality of mutually related requests. That is, terminal 100, upon detecting an operation input, judges that terminal 100 needs to be connected to the server for the present request (for password transmission in ST 17 shown in FIG. 5) using the communication network that was connected at the time of the previous request (display request in ST 2 shown in FIG. 5) and therefore can be connected to the server using the same communication network as the communication network used at the time the previous request was transmitted (here, communication network A shown in FIG. 1).

Thus, according to the present embodiment, a terminal, upon detecting an operation input, does not switch communication network connection even when the communication network connection is possible. That is, by controlling communication network connection between a plurality of mutually related requests, a terminal is allowed to continue providing service responding to the plurality of requests. Meanwhile, the terminal, if there is no problem switching communication network connection required by the occurrence of a plurality of requests (here, when there is no operation input between a plurality of requests), by switching the connection with communication networks, can perform more proper communication with a server. Therefore, according to the present embodiment, a terminal can correctly execute service from a server and switch connection to a more suitable communication network.

### Embodiment 2

There is a case where some servers can continue providing service without causing any problem even when a communication network is switched due to the occurrences of a plurality of mutually related requests such as password authentication. For example, it is now supposed that the server makes a request to input a password and assigns a unique identifier to that request. Next, the server commands the terminal to transmit a password together with that unique identifier. This enables the server to judge that a password has been transmitted from the same terminal so long as the unique identifier is the same even when the destination IP address of the password input request at the time of the request for inputting a password is different from the source IP address of the password at time of receiving the password.

The terminal does not need to manage the connection switching of a communication network described in Embodiment 1 so long as the terminal is provided with services from the server that can correctly identify the terminal in spite of the switching of communication routes as described above. In other words, a terminal may simply switch the connection with a communication network as described in Embodiment 1 only when the terminal is provided service from a server that will have the problem of being unable to continue providing service if communication network connection is switched while service is being provided.

Therefore, according to the present embodiment, a terminal stores in memory a server that will have the problem of being unable to continue providing service if communication network connection is switched while providing service, and does not switch communication network connection.

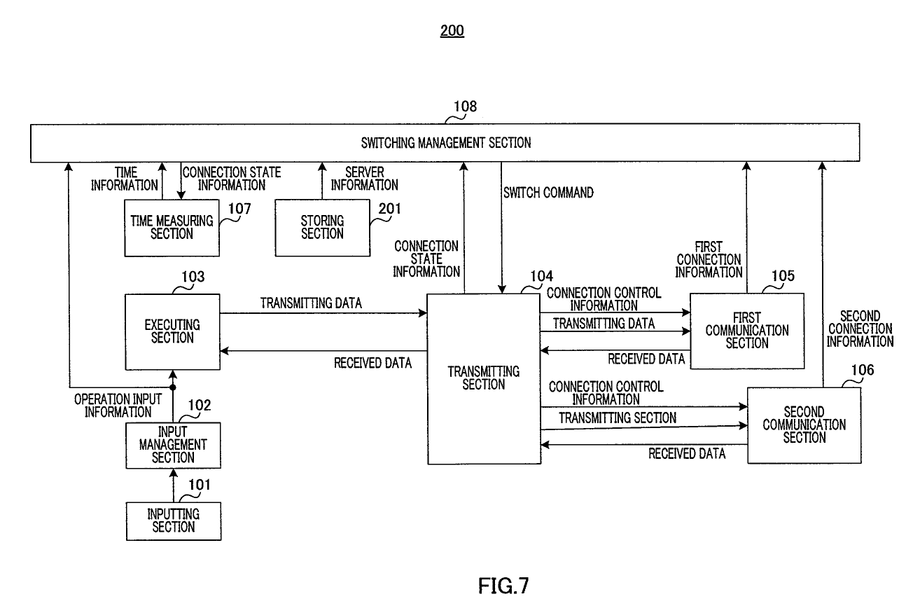

FIG. 7 illustrates configurations of terminal 200 of the present embodiment. In FIG. 7, the same reference numerals are assigned to the same configurations as in Embodiment 1 (FIG. 4) and descriptions thereof are omitted accordingly.

In terminal 200 shown in FIG. 7, storing section 201 stores in memory the server that will have the problem of being unable to continue providing service if communication network connection is switched while service is being provided. For example, storing section 201 stores the IP address of the sever. Here, storing section 201 may store in memory, in advance, the server that will have the problem of being unable to continue providing service if communication network connection is switched while service is being provided. Also, terminal 200 may update the information stored in storing section 201 based on the information notified from the system. Moreover, terminal 200 may determine the server whose information is to be stored in storing section 201 in accordance with the judgment of a user.

Switching management section 108, as in the case of Embodiment 1, is provided with operation-input information from input management section 102 and with information (for example, IP address of the server) about the server which provides services to terminal 200 from transferring section 104. Then, switching management section 108, when detecting operation-input information, and when the server (that is, the server that provides service to terminal 200) shown in the information contained in connection state information coincides with the server stored in memory by storing section 201, commands transferring section 104 not to switch the communication network connection.

Thus, according to the present embodiment, when terminal 200 is communicating with the server (that is, the server that cannot continue providing service due to the connection switching required by the occurrence of a plurality of requests) stored in memory by storing section 201 does not switch communication network connection. As in the case of Embodiment 1, this enables the prevention of service discontinuation caused by switching the connection with communication networks and normal execution of service.

Moreover, according to the present embodiment, terminal 200, when communicating with a server that is not stored in memory in storing section 201 (that is, a server that can switch communication network connection between a plurality of requests), may switch communication network connection at any time when it is possible to switch to a more suitable communication network.

### Embodiment 3

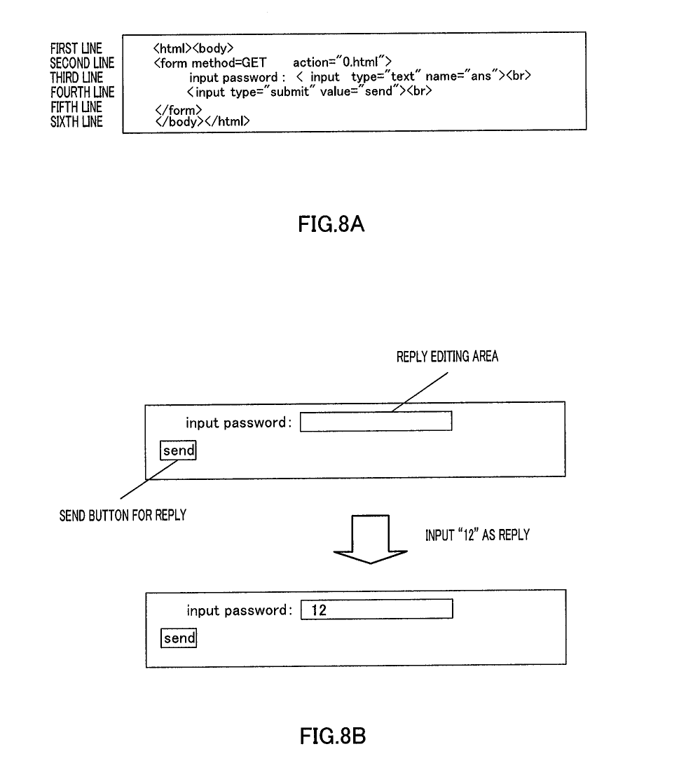

FIG. 8A shows one example of an HTML (Hyper Text Markup Language) tag contained in password input data (FIG. 2 and FIG. 5) used to request a password input as one example of a response from a server to a request from a terminal.

In FIG. 8A, the first and sixth lines represent HTML data. Moreover, the “form” elements on the second to fifth lines provide a definition of the method of responding from a terminal to a server and the “input” elements represent a command for the input format of that returning data.

More specifically, ‘method=GET’ on the second line in FIG. 8A shows that the method of returning data to a server is ‘GET’ and ‘action=“0.html”’ on the second line shows that the destination is ‘0. html’. Furthermore, ‘type=“text”’ on the third line in FIG. 8A shows that the content of the reply is a text format, and ‘name=“ans”’ in FIG. 8A shows that the name of the variable of data to be received as input is ‘ans’. In addition, ‘input password:’ at the head of the third line in FIG. 8A is a description to simply show a user what the input is. Moreover, ‘type=“submit”’ on the fourth line in FIG. 8A shows that a method of commanding a reply is a reply button and ‘value=“send”’ in FIG. 8A shows that the character string ‘send’ is displayed on the reply button. In addition, <br> on the third and fourth lines denotes a line feed.

When the HTML data shown in FIG. 8A is executed, the content shown in the upper part of FIG. 8B is displayed. To be more specific, as shown in the upper column in FIG. 8B, in response to the description on the third line in FIG. 8A, a reply editing area is displayed, and, in response to the command on the fourth line in FIG. 8A, the send button for returning a reply is displayed.

Next, as shown in the lower column in FIG. 8B, when ‘12’ is received as reply data and the send button for returning a reply is clicked, ‘http://0.html?ans=12’ is displayed in a URL (Uniform Resource Locator) area of the browser. Here, ‘http://’ shows that the protocol to be used for communication with a server is HTTP (Hyper Text Transfer Protocol), ‘0.html’ shows the destination of reply data specified on the second line in FIG. 8A, ‘?’ shows a separating character to separate the destination address from the returning data, and ‘ans=12’ shows that the returning data is 12.

Additionally, as the method of returning data to a server, ‘POST’ and the like, other than ‘GET,’ are available.

Thus, in some cases, a response from a server to a request from a terminal might contain information to request a reply (passwords in FIG. 8A and FIG. 8B) from the terminal by an operation input. Therefore, when, for example, the HTML tag showing the definition of the above-described method of returning a reply (‘method=GET,’‘method=POST’ and so on) or the specification of inputting format (‘input’) is contained in the data (response) transmitted from the server, the terminal can judge that the terminal further has to reply to data (response) transmitted from the server. That is, when information to request a reply from a terminal via an operation input is contained in data transmitted from the server, the terminal can judge that the plurality of requests transmitted from the terminal to the server before and after that data, are requests to make up one service (that is, mutually related requests).

Thus, according to the present embodiment, when information (for example, HTML tag shown in FIG. 8A) to request a reply from a terminal by an operation input is contained in data (response) transmitted from a server, the terminal does not switch communication network connection.

Hereinafter, more specific description will be provided. According to terminal 100 (FIG. 4), operation input information to be received as input from input management section 102 to switching management section 108, is not required. In terminal 100 shown in FIG. 4, connection state information containing received data (for example, the HTML tag shown in FIG. 8A) being a response from the server providing service to terminal 100 is input from transferring section 104 to switching management section 108. Next, when the information (in FIG. 8A, ‘method=GET’ or ‘input’) to request a reply by an operation input is contained in data received from the server, switching management section 108 commands transferring section 104 not to switch communication network connection.

That is, when information to request a reply by an operation input is contained in data received from the server, switching management section 108 judges that operation input processing in response to that received data is performed by inputting section 101. In other words, when information to request a reply by an operation input is contained in data received from the server, switching management section 108 judges that the plurality of requests transmitted before and after the received data are related, and does not switch communication network connection.

On the other hand, when information to request a reply by an operation input is not contained in data received from the server, switching management section 108 judges that an operation input in response to that received data is not provided. In this case, if it is possible to switch to a more appropriate communication network, switching management section 108 commands transferring section 104 to switch the communication network.

As described above, according to the present embodiment, as in Embodiment 1, terminal 100 does not switch communication network connection while service responding to a plurality of mutually related requests is being executed. Therefore, according to the present embodiment, the same effect as for Embodiment 1 can be obtained.

In addition, the present embodiment is explained by using one example in which the definition of the method of returning a reply (‘method=GET’, ‘method=POST’ and the like) and specification of inputting format are contained in data received from the server. However, according to the present invention, data to be contained in received data is not limited to the definition of the method of returning a reply (‘method=GET’, ‘method=POST’ and the like) and specification of inputting format, and it is sufficient that any command used to return a reply to a server is contained in data to be received from the server.

Thus, embodiments of the present invention have been described.

Furthermore, a case has been described with the above embodiment where a password is input upon password authentication, as an example of an operation input. However, according to the present invention, an operation input is not limited to a password input, and can be, for example, a character input for email editing, on electronic bulletin board, and for online chatting.

The disclosure of Japanese Patent Application No. 2008-257022, filed on Oct. 2, 2008, including the specification, drawings, and abstract, is incorporated herein by reference in its entirety.

### INDUSTRIAL APPLICABILITY

The present invention can be applied to a communication system and the like.

1. A terminal apparatus comprising:
a managing section that manages switching of connection with a first communication network and a second communication network each serving as a communication route between the terminal apparatus and a server providing service to the terminal apparatus; and
an inputting section that performs an operation input for executing the service,
wherein, when the operation input is detected or when data transmitted from the server comprises information to request a reply by the operation input, the managing section does not switch the connection.

2. The terminal apparatus according to claim 1, further comprising a storing section that stores a server that causes a problem if the connection is switched while the service is being provided,
wherein, when the operation input is detected and the server to provide the service to the terminal apparatus and the server stored in the storing section match, the managing section does not switch the connection.

3. A connection switching management method comprising managing switching of connection with a first communication network and a second communication network each serving as a communication route between a terminal apparatus and a server providing service to the terminal apparatus,
wherein, when an operation input for executing the service is detected or when data transmitted from the server comprises information to request a reply by the operation input, the connection is not switched.
